(19) United States
(12) Patent Application Publication
(10) Pub. No.: US 2014/0348280 A1
(43) Pub. Date: Nov. 27, 2014

(54) CLOCK-EMBEDDED SERIAL DATA TRANSMISSION SYSTEM AND CLOCK RECOVERY METHOD

(71) Applicant: Raydium Semiconductor Corporation, Hsinchu (TW)

(72) Inventor: Da-Rong HUANG, Hualien City (TW)

(73) Assignee: RAYDIUM SEMICONDUCTOR CORPORATION, Hsinchu (TW)

(21) Appl. No.: 14/284,520

(22) Filed: May 22, 2014

(30) Foreign Application Priority Data
May 23, 2013 (TW) 102118214

(51) Int. Cl. H04L 7/00

(52) U.S. Cl. CPC H04L 7/0091
USPC 375/359

(57) ABSTRACT

A clock-embedded serial data transmission system is disclosed. The clock-embedded serial data transmission system includes a combinational logic circuit. The combinational logic circuit includes a clock window generator and a clock generator. The clock window generator is used to generate a first clock window according to two clock phases. The clock generator is coupled to a clock window generator and used to select a periodic data within the first clock window from a serial data signal according to the first clock window and generate a recovery clock accordingly.

### BACKGROUND OF THE INVENTION

1. Field of the Invention

This invention relates to a high-speed transmission interface, especially to a clock-embedded serial data transmission system and a clock recovery method.

2. Description of the Related Art

Please refer to FIG. 1A and FIG. 1B. In the high-speed transmission interface, if a clock is embedded in a data signal transmitted as shown in FIG. 1A, it is so-called “clock-embedded system”; if there is no clock existed as shown in FIG. 1B, it is so-called “clockless system”.

In the clock-embedded system, it is necessary to add the information of fixed period into the data signal and when the receiver receives the data signal, the clock can be recovered from the information of fixed period in the data signal. Therefore, it is important that how to correctly and rapidly recover the clock from the information of fixed period in the data signal and effectively prevent the failure of generating recover clock.

### SUMMARY OF THE INVENTION

Therefore, the invention provides a clock-embedded serial data transmission system and a clock recovery method to solve the above-mentioned problems occurred in the prior arts.

An embodiment of the invention is a clock-embedded serial data transmission system. In this embodiment, the clock-embedded serial data transmission system includes a combinational logic circuit. The combinational logic circuit includes a clock window generator and a clock generator. The clock window generator is used to generate a first clock window according to two clock phases. The clock generator is coupled to a clock window generator and used to select a periodic data within the first clock window from a serial data signal according to the first clock window and generate a recovery clock accordingly.

In an embodiment, the clock-embedded serial data transmission system further includes an edge detector and a clock phase selector. The edge detector is coupled to the clock generator and used for detecting a first time interval between the periodic data within the first clock window and a first edge of the first clock window and a second interval between the periodic data within the first clock window and a second edge of the first clock window, and determining whether the first time interval or the second time interval is smaller than a default value, wherein the first edge and the second edge are located at a first side and a second side of the periodic data respectively. The clock phase selector is coupled to the edge detector and the clock window generator, if the edge detector determines that the first time interval or the second time interval is smaller than the default value, the clock phase selector selects another two clock phases from a plurality of candidate clock phases again and the clock window generator generates a second clock window according to the another two clock phases.

In an embodiment, if the edge detector determines that the first time interval is smaller than the default value, the first edge of the first clock window is too close to the periodic data, the another two clock phases selected by the clock phase selector are located at the first side of the two clock phases, and the second clock window generated by the clock window generator is located at the first side of the first clock window.

In an embodiment, if the edge detector determines that the second time interval is smaller than the default value, the second edge of the first clock window is too close to the periodic data, the another two clock phases selected by the clock phase selector are located at the second side of the two clock phases, and the second clock window generated by the clock window generator is located at the second side of the first clock window.

In an embodiment, the default value is the shortest time needed for the clock generator to generate the recovery clock.

In an embodiment, the periodic data in the serial data signal is a rising edge or a falling edge of a clock.

Another embodiment of the invention is a clock recovery method. In this embodiment, the clock recovery method includes steps of: (a) generating a first clock window according to two clock phases; (b) selecting a periodic data within the first clock window from a serial data signal according to the first clock window; and (c) generating a recovery clock according to the periodic data.

Compared to the prior art, the clock-embedded serial data transmission system and the clock recovery method of the invention use multiple clock phases to generate a clock window and use the clock window to select a periodic data (e.g., the rising edge or the falling edge of the clock) from a serial data signal and the clock generator will generate a recovery clock accordingly. In addition, in order to provide enough time for the clock generator to generate the recovery clock, the clock-embedded serial data transmission system of the invention uses an edge detector to detect whether the time intervals between the periodic data of the serial data signal and the two edges of the clock window are too small. Once the edge detector detects that the periodic data is too close to one of the two edges of the clock window, the clock phase selector will select another two clock phases again to generate another clock window, so that proper time intervals between the periodic data and two edges of the another clock window can be maintained to provide enough time for the clock generator to generate the recovery clock.

The advantage and spirit of the invention may be understood by the following detailed descriptions together with the appended drawings.

### BRIEF DESCRIPTION OF THE DRAWINGS

FIG. 1A illustrates a schematic diagram of a clock embedded in the data signal transmitted in the conventional clock-embedded system.

FIG. 1B illustrates a schematic diagram of no clock existed in the data signal in the conventional clockless system.

FIG. 2 illustrates a schematic diagram of the clock-embedded serial data transmission system in an embodiment of the invention.

FIG. 3 illustrates a timing diagram of the signals shown in FIG. 2.

FIG. 4A illustrates a clock embedded in a serial data signal; FIG. 4B, FIG. 4C, and FIG. 4D illustrate different clock windows respectively.

FIG. 5 illustrates a flow chart of the clock recovery method in another embodiment of the invention.

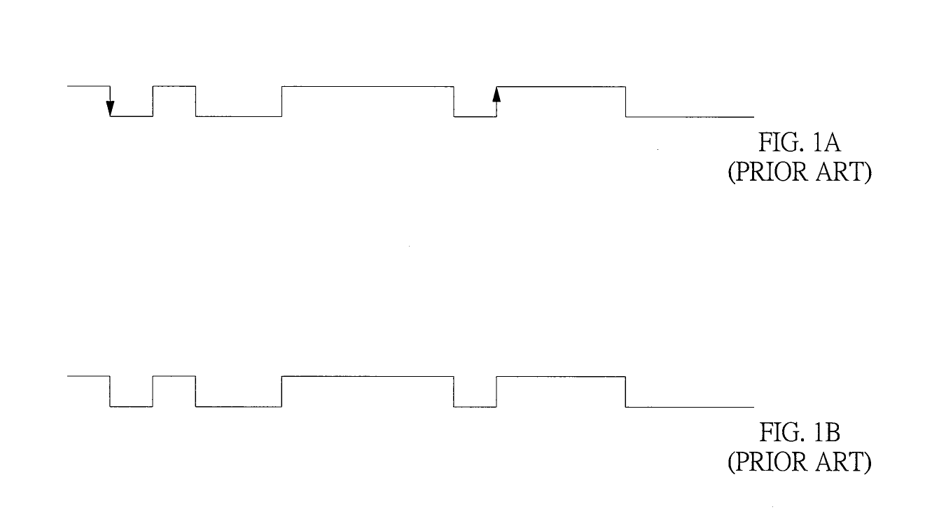

### DETAILED DESCRIPTION

A preferred embodiment of the invention is a clock-embedded serial data transmission system. In this embodiment, a clock is embedded in a data signal and the data signal is transmitted in a high-speed transmission interface. The clock-embedded serial data transmission system of the embodiment uses multiple clock phases to generate a clock window and use the clock window to select a periodic data (e.g., the rising edge or the falling edge of the clock) from a serial data signal for the clock generator to generate a recovery clock accordingly.

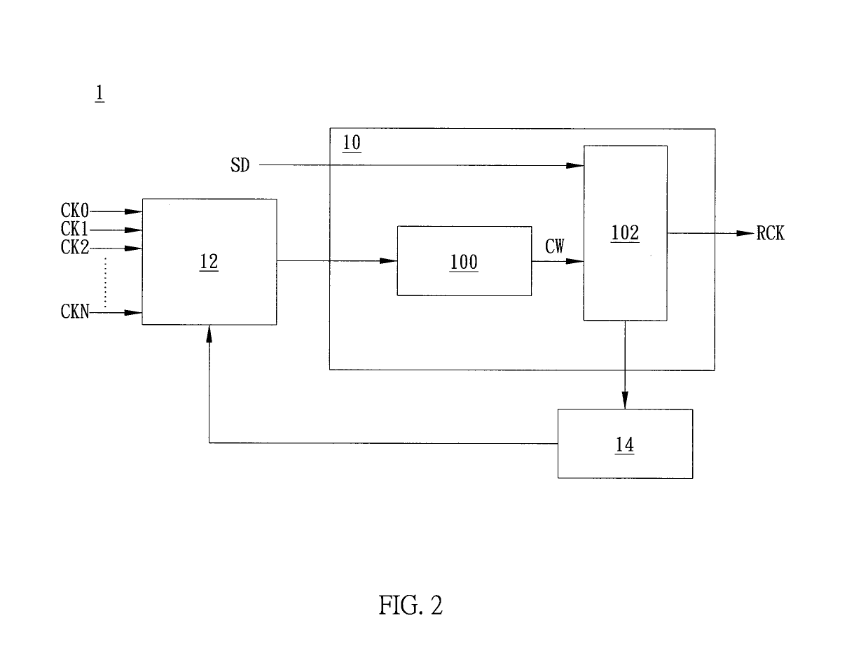

Please refer to FIG. 2. FIG. 2 illustrates a schematic diagram of the clock-embedded serial data transmission system in this embodiment. As shown in FIG. 2, the clock-embedded serial data transmission system 1 includes a combinational logic circuit 10, a clock phase selector 12, and an edge detector 14. The combinational logic circuit 10 includes a clock window generator 100 and a clock generator 102. Wherein, the clock phase selector 12 is coupled to the clock window generator 100; the clock window generator 100 is coupled to the clock generator 102; the clock generator 102 is coupled to the edge detector 14; the edge detector 14 is coupled to the clock phase selector 12.

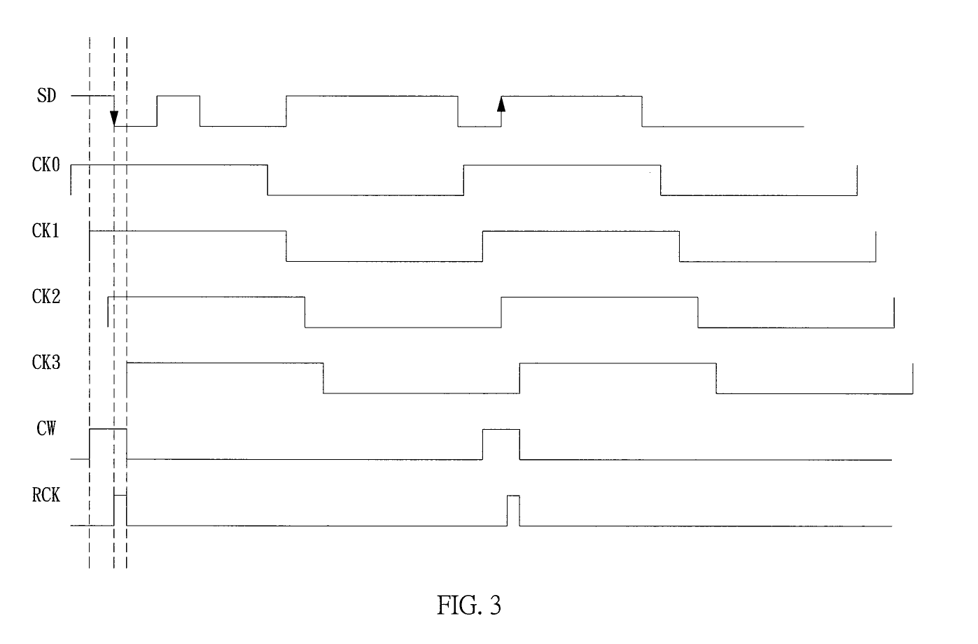

The clock phase selector 12 is used to receive multiple clock phases, for example, the different clock phases CK0˜CKN (N is a positive integer) shown in FIG. 3, and then the clock phase selector 12 selects two clock phases (e.g., CK1 and CK3) from the different clock phases CK0˜CKN. Next, the clock window generator 100 receives the two clock phases CK1 and CK3 from the clock phase selector 12 and generates a clock window CW shown in FIG. 3 according to the two clock phases CK1 and CK3. In this embodiment, the clock window generator 100 forms a first edge and a second edge at the left side and the right side of the clock window CW according to rising edges of the two clock phases CK1 and CK3 shown in FIG. 3, but not limited to this.

Then, the clock generator 102 selects a periodic data FE (e.g., the falling edge as the arrow of FIG. 3 shows) within the clock window CW from a serial data signal SD according to the clock window CW and generates a recovery clock RCK shown in FIG. 3 according to the periodic data FE.

In order to make sure that the clock generator 102 can smoothly generate the recovery clock RCK, the edge detector 14 will detect a first time interval between the periodic data FE and a first edge of the clock window CW and a second time interval between the periodic data FE and a second edge of the clock window CW and then the edge detector 14 will determine whether the first time interval or the second time interval is smaller than a default value to obtain information about whether the periodic data FE is too close to the edges of the clock window CW.

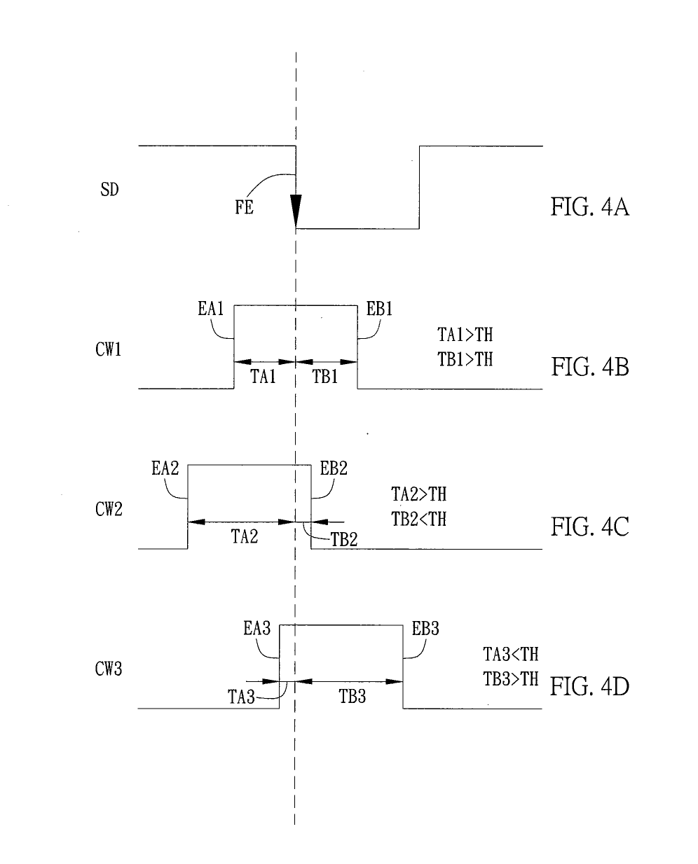

Please refer to FIG. 4A˜FIG. 4D. FIG. 4A illustrates a clock embedded in a serial data signal SD; FIG. 4B, FIG. 4C, and FIG. 4D illustrate different clock windows CW1˜CW3 respectively.

Taking the clock window CW1 of FIG. 4B for example, the edge detector 14 will detect a first time interval TA1 between the periodic data FE of the serial data signal SD and the first edge EA1 of the clock window CW1 and a second time interval TB1 between the periodic data FE serial data signal SD and the second edge EB1 of the clock window CW1 and then the edge detector 14 will determine whether the first time interval TA1 or the second time interval TB1 is smaller than the default value TH. In fact, the default value TH can be adjusted based on practical needs; for example, the default value TH can be zero or the shortest time needed for the clock generator 102 to generate the recovery clock RCK. Obviously, as to the clock window CW1 of FIG. 4B, the edge detector 14 will determine that both the first time interval TA1 and the second time interval TB1 are larger than the default value TH. This represents that the clock generator 102 will have enough time to generate the recovery clock RCK. Therefore, it is unnecessary to select other clock phases to generate another clock window.

Taking the clock window CW2 of FIG. 4C for example, the edge detector 14 will detect a first time interval TA2 between the periodic data FE of the serial data signal SD and the first edge EA2 of the clock window CW2 and a second time interval TB2 between the periodic data FE of the serial data signal SD and the second edge EB2 of the clock window CW2 and then the edge detector 14 will determine whether the first time interval TA2 or the second time interval TB2 is smaller than the default value TH. In this embodiment, as to the clock window CW2 of FIG. 4C, the edge detector 14 will determine that the first time interval TA2 is larger than the default value TH, but the second time interval TB2 is smaller than the default value TH. This represents that the clock generator 102 may not have enough time to generate the recovery clock RCK. Therefore, the edge detector 14 will control the clock phase selector 12 to select another two clock phases from a plurality of candidate clock phases for the clock window generator 100 to generate a new clock window which is appeared later than the original clock window CW2 and the edges of the new clock window are appeared later than the first edge EA2 and the second edge EB2 of the original clock window CW2. The new clock window will be similar to the ideal clock window CW1 of FIG. 4B.

Similarly, taking the clock window CW3 of FIG. 4D for example, the edge detector 14 will detect a first time interval TA3 between the periodic data FE of the serial data signal SD and the first edge EA3 of the clock window CW3 and a second time interval TB3 between the periodic data FE of the serial data signal SD and the second edge EB3 of the clock window CW3 and then the edge detector 14 will determine whether the first time interval TA3 or the second time interval TB3 is smaller than the default value TH. In this embodiment, as to the clock window CW3 of FIG. 4D, the edge detector 14 will determine that the second time interval TB3 is larger than the default value TH, but the first time interval TA3 is smaller than the default value TH. This represents that the clock generator 102 may not have enough time to generate the recovery clock RCK. Therefore, the edge detector 14 will control the clock phase selector 12 to select another two clock phases from a plurality of candidate clock phases for the clock window generator 100 to generate a new clock window which is appeared earlier than the original clock window CW3 and the edges of the new clock window are appeared earlier than the first edge EA3 and the second edge EB3 of the original clock window CW3. The new clock window will be similar to the ideal clock window CW1 of FIG. 4B.

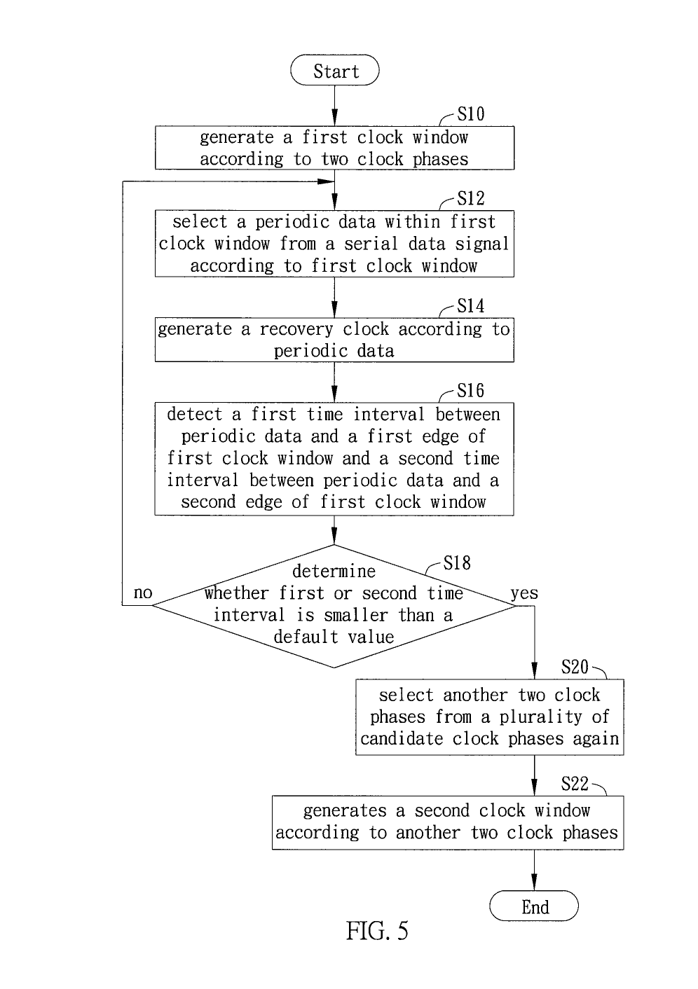

Another embodiment of the invention is a clock recovery method. In this embodiment, the clock recovery method is used in the clock-embedded serial data transmission system, but not limited to this. Please refer to FIG. 5. FIG. 5 illustrates a flow chart of the clock recovery method in this embodiment.

As shown in FIG. 5, the clock recovery method includes following steps. In the step S10, the method generates a first clock window according to two clock phases. In the step S12, the method selects a periodic data within the first clock window from a serial data signal according to the first clock window. In fact, the periodic data in the serial data signal is a rising edge or a falling edge of the clock. In the step S14, the method generates a recovery clock according to the periodic data.

In the step S16, the method detects a first time interval between the periodic data within the first clock window and a first edge of the first clock window and a second time interval between the periodic data within the first clock window and a second edge of the first clock window, wherein the first edge and the second edge are located at a first side and a second side of the periodic data respectively. In the step S18, the method determines whether the first time interval or the second time interval is smaller than a default value. Wherein, the default value is the shortest time needed for generating the recovery clock in the step S14. If the determining result of the step S18 is yes, namely the step S18 determines that the first time interval or the second time interval is smaller than the default value, the method performs the step S20 to select another two clock phases from a plurality of candidate clock phases again. In the step S22, the method generates a second clock window according to the another two clock phases.

If the step S18 determines that the first time interval is smaller than the default value, it represents that the first edge of the first clock window is too close to the periodic data, the another two clock phases selected in the step S20 are located at the first side of the two clock phases, so that the second clock window generated in the step S22 will be located at the first side of the first clock window.

If the step S18 determines that the second time interval is smaller than the default value, it represents that the second edge of the first clock window is too close to the periodic data, the another two clock phases selected in the step S20 are located at the second side of the two clock phases, so that the second clock window generated in the step S22 will be located at the second side of the first clock window.

Compared to the prior art, the clock-embedded serial data transmission system and the clock recovery method of the invention use multiple clock phases to generate a clock window and use the clock window to select a periodic data (e.g., the rising edge or the falling edge of the clock) from a serial data signal and the clock generator will generate a recovery clock accordingly. In addition, in order to provide enough time for the clock generator to generate the recovery clock, the clock-embedded serial data transmission system of the invention uses an edge detector to detect whether the time intervals between the periodic data of the serial data signal and the two edges of the clock window are too small. Once the edge detector detects that the periodic data is too close to one of the two edges of the clock window, the clock phase selector will select another two clock phases again to generate another clock window, so that proper time intervals between the periodic data and two edges of the another clock window can be maintained to provide enough time for the clock generator to generate the recovery clock.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A clock-embedded serial data transmission system, comprising:
a combinational logic circuit, comprising:
a clock window generator, for generating a first clock window according to two clock phases; and
a clock generator, coupled to the clock window generator, for selecting a periodic data within the first clock window from a serial data signal according to the first clock window and generating a recovery clock according to the periodic data.

2. The clock-embedded serial data transmission system of claim 1, further comprising:
an edge detector, coupled to the clock generator, for detecting a first time interval between the periodic data within the first clock window and a first edge of the first clock window and a second time interval between the periodic data within the first clock window and a second edge of the first clock window, and determining whether the first time interval or the second time interval is smaller than a default value, wherein the first edge and the second edge are located at a first side and a second side of the periodic data respectively; and
a clock phase selector, coupled to the edge detector and the clock window generator, if the edge detector determines that the first time interval or the second time interval is smaller than the default value, the clock phase selector selecting another two clock phases from a plurality of candidate clock phases again and the clock window generator generating a second clock window according to the another two clock phases.

3. The clock-embedded serial data transmission system of claim 2, wherein if the edge detector determines that the first time interval is smaller than the default value, the first edge of the first clock window is too close to the periodic data, the another two clock phases selected by the clock phase selector are located at the first side of the two clock phases, and the second clock window generated by the clock window generator is located at the first side of the first clock window.

4. The clock-embedded serial data transmission system of claim 2, wherein if the edge detector determines that the second time interval is smaller than the default value, the second edge of the first clock window is too close to the periodic data, the another two clock phases selected by the clock phase selector are located at the second side of the two clock phases, and the second clock window generated by the clock window generator is located at the second side of the first clock window.

5. The clock-embedded serial data transmission system of claim 2, wherein the default value is the shortest time needed for the clock generator to generate the recovery clock.

6. The clock-embedded serial data transmission system of claim 1, wherein the periodic data in the serial data signal is a rising edge or a falling edge of a clock.

7. A clock recovery method, comprising steps of:
(a) generating a first clock window according to two clock phases;
(b) selecting a periodic data within the first clock window from a serial data signal according to the first clock window; and
(c) generating a recovery clock according to the periodic data.

8. The clock recovery method of claim 7, further comprising steps of:
(d) detecting a first time interval between the periodic data within the first clock window and a first edge of the first clock window and a second time interval between the periodic data within the first clock window and a second edge of the first clock window, wherein the first edge and the second edge are located at a first side and a second side of the periodic data respectively;
(e) determining whether the first time interval or the second time interval is smaller than a default value;
(f) if the step (e) determines that the first time interval or the second time interval is smaller than the default value, selecting another two clock phases from a plurality of candidate clock phases again; and
(g) generating a second clock window according to the another two clock phases.

9. The clock recovery method of claim 8, wherein if the step (e) determines that the first time interval is smaller than the default value, the first edge of the first clock window is too close to the periodic data, the another two clock phases selected in the step (f) are located at the first side of the two clock phases, and the second clock window generated in the step (g) is located at the first side of the first clock window.

10. The clock recovery method of claim 8, wherein if the step (e) determines that the second time interval is smaller than the default value, the second edge of the first clock window is too close to the periodic data, the another two clock phases selected in the step (f) are located at the second side of the two clock phases, and the second clock window generated in the step (g) is located at the second side of the first clock window.

11. The clock recovery method of claim 8, wherein the default value is the shortest time needed for the step (c) to generate the recovery clock.

12. The clock recovery method of claim 7, wherein the periodic data in the serial data signal is a rising edge or a falling edge of a clock.
